(19) United States
(12) Patent Application Publication
(10) Pub. No.: US 2007/0139557 A1
(43) Pub. Date: Jun. 21, 2007

(54) PERSONAL COMPUTER MOTHERBOARD WITH ON-BOARD VIDEO COMPRESSION CAPABILITY

(76) Inventor: Eli Arad, Givat Smoel (IL)

Correspondence Address: MCANDREWS HELD & MALLOY, LTD, 500 WEST MADISON STREET, SUITE 3400, CHICAGO, IL, 60661, US

(21) Appl. No.: 11/612,855

(22) Filed: Dec. 19, 2006

Related U.S. Application Data
(60) Provisional application No. 60/751,923, filed on Dec. 19, 2005.

(51) Int. Cl. H04N 5/445

(52) U.S. Cl. 348/568

(57) ABSTRACT

A personal computer motherboard with on-board video compression capability and a method in a personal computer motherboard for compressing video information utilizing on-board video compression circuitry. Various aspects of the present invention provide a CPU and memory disposed on a PC motherboard. The PC motherboard may also comprise one or more video input interfaces. The PC motherboard may further comprise at least one module comprising an on-board video compression circuit, where the at least one module is adapted to receive a video signal through the video input interface and utilize the on-board video compression circuit to compress the received video signal to produce compressed video information. The PC motherboard may also, in various non-limiting exemplary scenario, comprise various communication modules (e.g., dedicated and/or general) for communicating the compressed video information to devices external to the PC motherboard.

### CROSS-REFERENCE TO RELATED APPLICATIONS/INCORPORATION BY REFERENCE

The present application is related to and claims priority from U.S. Provisional Patent Application Ser. No. 60/751,923, with attorney docket number 16422US01, filed Dec. 19, 2005, and titled “PERSONAL COMPUTER MOTHERBOARD WITH ON-BOARD VIDEO COMPRESSION CAPABILITY,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Digital video information processing is increasing in popularity. For example and without limitation, personal computers are utilized for video conferencing and other video interaction. Also for example, personal computers are utilized to process video information into moving picture files or streams and/or to communicate such moving picture files or streams to other systems. Further for example, personal computers are also utilized for electronic surveillance. Still further for example, personal computers are interfaced with personal video camera hardware. The video-processing capability of current personal computers is inadequate for various increasingly common video-related usages (e.g., usages involving real-time video compression).

Various expansion cards are available to enhance video processing capability of personal computers. Such expansion cards are typically relatively expensive, often relatively difficult to install, and generally have relatively complex and unique respective application or user interfaces. For example, software developed for use with a first video expansion card is not generally compatible with software developed for use with a second video expansion card.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a personal computer motherboard with on-board video compression capability and a method in a personal computer motherboard for compressing video information utilizing on-board video compression circuitry, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a block diagram illustrating an exemplary personal computer motherboard, in accordance with various aspects of the present invention.

FIG. 2 is a block diagram illustrating an exemplary personal computer motherboard, in accordance with various aspects of the present invention.

FIG. 3 is a flow diagram illustrating an exemplary method, in a personal computer motherboard, for performing video compression, in accordance with various aspects of the present invention.

FIG. 4 is a flow diagram illustrating an exemplary method, in a personal computer motherboard, for performing video compression, in accordance with various aspects of the present invention.

### DETAILED DESCRIPTION OF THE INVENTION

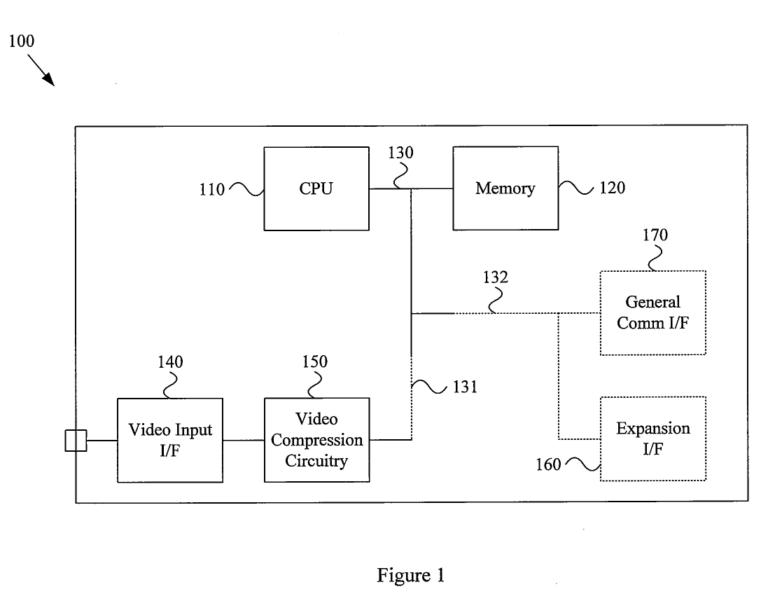

FIG. 1 is a block diagram illustrating a personal computer motherboard 100, in accordance with various aspects of the present invention. The personal computer motherboard 100 (and other motherboards discussed herein) may, for example, be utilized in any of a variety of personal computer systems. Such systems may, for example, be based on any of a variety of microprocessors and/or any of a variety of motherboard chipsets. Such systems may, for example, be produced by any of a variety of companies in the business of producing such systems.

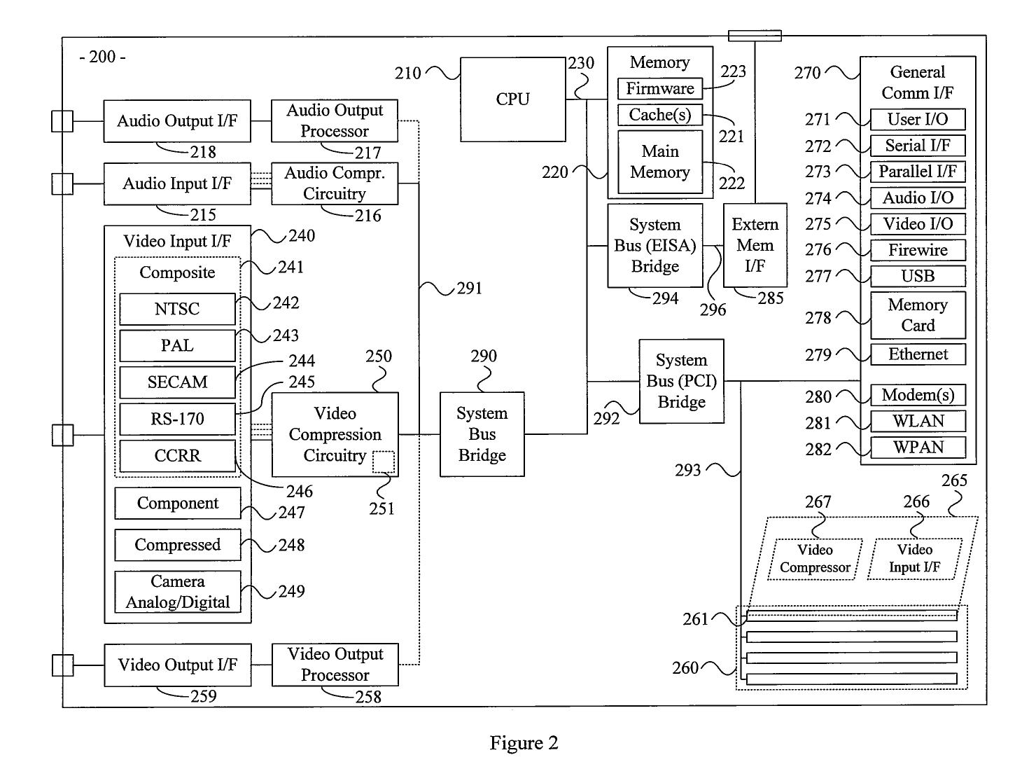

The personal computer (“PC”) motherboard 100 may comprise any of a large variety of components, a portion of which are illustrated in FIG. 1. For example and without limitation, the PC motherboard 100 may comprise a CPU 110. The PC motherboard 100 may also comprise a Memory 120, which may, for example, be communicatively coupled to the CPU 110 by a system bus 130. The PC motherboard 100 may also comprise a general communication interface 170 communicatively coupled to the CPU 110 (e.g., through a secondary bus 132 and/or the system bus 130). The PC motherboard 100 may further comprise an expansion interface 160 communicatively coupled to the CPU 110 (e.g., through a secondary bus 132 and/or the system bus 130). The PC motherboard 100 may also comprise a video input interface 140 and on-board video compression circuitry 150 communicatively coupled to the CPU 110 (e.g., through a secondary bus 131 and/or the system bus 130). Other exemplary PC motherboard components will be discussed later in the discussion of FIG. 2.

The CPU 110 may comprise any of a variety of central processing units (e.g., presently available or to be available in the future). The CPU 110 may comprise any of a variety of microprocessor types. The CPU 110 generally controls operation of the PC motherboard 100 and thus, the personal computer into which the PC motherboard 100 is installed. The CPU 110 may generally interface with other components of the PC motherboard 100 through the system bus 130 (and/or other buses).

The memory 120 may comprise characteristics of any of a variety of memory types. For example and without limitation, the memory 120 may comprise volatile or non-volatile memory. The memory 120 may, for example, comprise static RAM and/or dynamic RAM. The memory 120 may, for example, comprise firmware. The memory 120 may also, for example, comprise one or more memory caches (e.g., utilized by the CPU 110 for instruction and/or data caching). Though the memory 120 is illustrated in FIG. 1 as one block, it should be recognized that the memory 120 might comprise any, or any combination, of a variety of memory devices or memory device types.

The memory 120 may generally be utilized by the CPU 110 to store instructions that the CPU 110 may execute. For example, the memory 120 may store instructions that the CPU 110 may execute to process video and/or audio information. The CPU 110 may, for example, manage the loading of instructions into the memory 120 to achieve efficient instruction execution. The CPU 110 may also utilize the memory 120 to store data being processed or the results of data processing. Such data may represent any of a variety of data types, including without limitation, video data and audio data.

As illustrated in FIG. 1, a system bus 130 may communicatively couple the memory 120 (or portions thereof) and the CPU 110. The system bus 130 may, in turn, be communicatively coupled to one or more other buses (e.g., secondary or tertiary buses). Two exemplary secondary buses 131, 132 are illustrated in FIG. 1. Such communicative coupling between buses may, for example, be performed using various bus bridging circuitry.

The video input interface 140 may comprise one or more various modules adapted to receive any of a variety of types of video signals. For example and without limitation, the video input interface 140 may be adapted to receive one or more color composite video signals. Such signals may, for example, be based on the National Television Standards Committee (“NTSC”) standard, the Phase Alternation Line (“PAL”) standard and/or the Systeme Electronic Pour Coleur Avec Memoire (“SECAM”) standard. Also for example, the video input interface 140 may be adapted to receive one or more monochrome video signals. Such signals may, for example, be based on the RS-170 standard (related to NTSC) and/or the CCRR standard (related to PAL).

The video input interface 140 may also, for example, comprise one or more modules adapted to receive video signals from any of a variety of cameras. Such cameras may, for example, comprise characteristics of analog and/or digital video cameras. Video signals associated with such cameras may, for example, comprise characteristics associated with any of a variety of video standards and/or camera vendor-specific (e.g., propriety) signal definitions. Such cameras may, for example, comprise characteristics of general-purpose video cameras, web-cams, surveillance cameras, etc. The video input interface 140 may also, for example, comprise one or more modules adapted to receive component video signals. Such component video signals may, for example, comprise RGB or YCrCb video components.

The video input interface 140 may additionally, for example, comprise one or more modules adapted to receive compressed video signals. For example and without limitation, such compressed video signals may comprise characteristics associated with various video compression standards (e.g., MPEG-1, MPEG-2, MPEG-4, MPEG-4 part 10, various non-MPEG compression standards or techniques, etc.). Such modules may, for example, be adapted to communicate information in accordance with the various transport layers defined for the various compression standards.

Note that the video input interface 140 may be adapted to receive any number of video signals (e.g., one, two, four or N video signals). In other words, the video input interface 140 may comprise any of, any combination of, or any number of the previously discussed modules.

The previously discussed exemplary video signals are merely exemplary. Accordingly, the scope of various aspects of the present invention should not be limited by characteristics of any particular video standard or signal type or by characteristics of any particular hardware and/or software utilized to receive such signals.

The on-board video compression circuitry 150 may, for example, comprise electronic hardware dedicated to the compression of video information. Such dedicated compression hardware may, for example, also comprise accompanying firmware and/or software. The on-board video compression circuitry 150 may comprise any of a variety of video compression circuitry, including but not limited to, various types of moving picture encoding circuitry. For example, the on-board video compression circuitry 150 may comprise one or more MPEG-2 and/or MPEG-4 compression circuits. Also for example, the on-board video compression circuitry 150 may comprise one or more MPEG-4 part 10 (or H.264) compression circuits. In a non-limiting exemplary scenario where the on-board video compression circuitry 150 comprises a plurality of such compression circuits, the on-board video compression circuitry 150 may be adapted to utilize at least a portion of such compression circuits to concurrently (or simultaneously) compress a plurality of video signals received by the video input interface 140.

The on-board video compression circuitry 150 may, for example, be adapted to perform real-time compression of video information (e.g., as received by the video input interface 140). For example and without limitation, the on-board video compression circuitry 150 may be adapted to perform such video compression at rates not generally achievable by the CPU 110 executing software instructions (e.g., while also performing general CPU functions).

In one non-limiting exemplary scenario, the on-board video compression circuitry 150 may be configurable to perform video compression in accordance with any one or more of a variety of video compression techniques. For example, the on-board video compression circuitry 150 may comprise memory (or may utilize memory external to the video compression circuitry 150) to store information that governs operation of the on-board video compression circuitry 150. Such information may, for example, comprise information indicating which video compression technique to perform and/or information indicating how particular components of the video compression circuitry 150 (e.g., encoders, filters, A/D converters, quantizers, interpolators, etc.) are to perform their respective processing functions.

The on-board video compression circuitry 150 may be communicatively coupled to the CPU 110. Such communicative coupling may be direct or indirect. For example and without limitation, the on-board video compression circuitry 150 may be directly coupled to the system bus 130. Also for example, the on-board video compression circuitry 150 may be directly coupled to a secondary bus 131 (e.g., a bus dedicated to communicating video or multi-media information), which in turn, is coupled to the system bus 130 through bus bridging circuitry.

The expansion interface 160 may be adapted to interface with any of a variety of motherboard expansion cards. For example and without limitation, the expansion interface 160 may be adapted to interface with a video card that is adapted to (e.g., among other things) receive and compress a video signal. Such a video card may, for example, comprise any of a variety video compression circuitry.

In an exemplary scenario, where the expansion interface 160 is interfacing with a video card, the memory 120 (or other memory of the motherboard) may store at least one software module that, when executed by a processor (e.g., the CPU 110), results in the processor managing the on-board video compression circuitry 150 and the video card. For example, in the exemplary scenario, the processor may execute the software module(s) and thereby coordinate simultaneous use of the on-board video compression circuitry 150 and the video card. Also for example, in the exemplary scenario, the processor may execute the software module(s) and thereby select between (and/or time multiplex) video information associated with the on-board video compression circuit 150 and video information associated with the video card. Further for example, in the exemplary scenario, the processor may execute the software module(s) and thereby select between utilizing one or the other of the on-board video compression circuitry 150 and the video card. Though the exemplary scenario comprises utilizing the on-board video compression circuitry 150 and the video card with a processor executing software instructions, such utilization (or various portions thereof) may alternatively be performed by dedicated hardware.

The expansion interface 160 may be communicatively coupled to the CPU 110. Such communicative coupling may be direct or indirect. For example and without limitation, the expansion interface 160 may be directly coupled to the system bus 130. Also for example, the expansion interface 160 may be directly coupled to a secondary bus 132 (e.g., a Peripheral Component Interconnect (“PCI”) bus or other peripheral communication bus), which in turn is coupled to the system bus 130 through bus bridging circuitry.

The general communication interface 170 may generally comprise hardware and/or software modules adapted to communicate with devices external to the PC motherboard 100. Such modules may, for example and without limitation, comprise one or modules adapted to provide user interface functionality. The general communication interface 170 may also, for example, comprise one or more serial and/or parallel interface modules. Additionally for example, the general communication interface 170 may comprise one or more audio interface modules and/or video interface modules. Further for example, the general communication interface 170 may comprise one or more modules adapted to implement communication via firewire and/or USB. Still further for example, the general communication interface 170 may comprise one or more modules adapted to communicate with a removable memory card or memory stick.

The general communication interface 170 may, for example, comprise one or more modules adapted to communicate between the motherboard 100 and a device external to the motherboard 100 via modem (e.g., an internal or external modem). Such a modem may, for example, comprise characteristics of a television cable modem or telephone network modem. Also for example, the general communication interface 170 may comprise one or more modules adapted to communicate over any of a variety of computer communication networks utilizing any of a variety of computer communication network protocols. For example, such module(s) may be adapted to communicate over Ethernet or Token Ring networks. Also for example, such module(s) may be adapted to communicate over any of a variety of wireless computer communication networks (e.g., a Wireless Local Area Network (“WLAN”) and/or Wireless Personal Area Network (“WPAN”)). Further for example, such module(s) may be adapted to communicate information directly to various external devices (e.g., a video display device, television, television set top box, satellite receiver, etc.).

The general communication interface 170 (or a portion thereof) may be adapted to communicate compressed video information (e.g., from the on-board video compression circuitry 150) to a device external to the PC motherboard 100. Such communication may, for example, be governed by the on-board video compression circuitry 150 and/or the CPU 110. Such communication may, for example, occur utilizing any of the exemplary interface modules presented above and many others that were not explicitly mentioned. For example, such communication may occur utilizing a modem and/or modem interface of the general communication interface 170 (e.g., a cable modem or telephone modem). Also for example, such communication may occur utilizing any of a variety of computer network interface modules (e.g., Ethernet, Token Ring, WLAN, WPAN, etc.). Further for example, such communication may occur utilizing one or more modules adapted to communicate video information directly to a video display system, television, television set top box, satellite receiver, etc.).

The general communication interface 170 (or a portion thereof, for example, a video output module) may be adapted to communicate non-compressed video information to one or more video devices or video display systems external to the PC motherboard 100. For example, the general communication interface 170 (e.g., a video output module) may be adapted to communicate a received video signal (e.g., as received by the video input interface 140) to a device external to the PC motherboard 100. Such communication may, for example, be generally governed by the CPU 110, or alternatively, the video compression circuitry 150 and/or the video input interface 140. The received video signal (or a signal representative thereof) may, for example, be communicated to the external device while the video compression circuitry 150 is compressing the received video signal.

The general communication interface 170 (or a portion thereof, for example, a video output module) may also be adapted to communicate compressed video information (e.g., from the on-board video compression circuitry 150) to one or more video devices or video display systems external to the PC motherboard 100. Such compressed video information may, for example, correspond exactly to compressed video information formed by the on-board video compression circuitry 150 or may correspond approximately to such compressed video information. Such compressed video information may also, for example, correspond to compressed video information that might be received by the video input interface 140.

In communicating video information, the general communication interface 170 (or a portion thereof, for example, a video output module) may communicate analog and/or digital video signals. Such signals may comprise characteristics of any of a variety of video signals, including without limitation, composite color, monochrome, component or digital video signals. Further for example, the general communication interface 170 may be adapted to communicate one or any number of such signals.

The general communication interface 170 may also, for example, comprise various audio input/output modules. For example, the general communication interface 170 (or a portion thereof, for example, an audio input module) may be adapted to receive an audio signal. The audio signal may, for example, correspond to a video signal received by the video input interface 140 or a video input module of the general communication interface 170. Various modules of the PC motherboard 100 may, for example, be adapted to compress received audio information. Such modules may, for example, comprise hardware and/or software (e.g., software executed by the CPU 110). Also for example, various modules of the PC motherboard 100 may be adapted to synchronize received analog information (or signals) with received video information (or signals). In a non-limiting exemplary scenario, various modules of the PC motherboard 100 may be adapted to receive, compress and synchronize video and audio signals associated with a particular multimedia program.

The PC motherboard 100 may comprise any of a variety of additional hardware and/or software modules. For example and without limitation, the PC motherboard 100 may comprise a moving picture software module stored in the memory 120, where the moving picture software, when executed by a processor (e.g., the CPU 110), causes the processor to form a moving picture file (e.g., an mpeg file or other file) from compressed video information. The PC motherboard 100 may also, for example, comprise compression control information stored in the memory 120 (or, for example, a memory of the on-board video compression circuitry 150), where such compression control information controls the manner in which the on-board video compression circuitry 150 compresses received video information.

In a non-limiting exemplary scenario in which the on-board video compression circuitry 150 is capable of compressing received video information in accordance with any of a plurality of video compression standards or techniques, the compression control information may comprise information indicating which of the plurality of video compression standards and/or techniques the on-board compression circuitry 150 is to perform. Such information may, for example, be stored in volatile or non-volatile memory.

In another non-limiting exemplary scenario, the PC motherboard 100 may comprise a plurality of software subroutines stored in the memory 120, where such subroutines are accessible to programmers that provide video applications for the PC motherboard 100. For example, the plurality of software subroutines may serve as an interface between application software executing on the CPU 110 and the on-board video compression circuitry 150. Such subroutines may, for example, comprise an application programmer interface. Such subroutines may, for example, generally reside on the PC motherboard 100 or may, for example, be loaded into the memory 120 from another memory (e.g., a hard drive) when needed. In another exemplary scenario, a library of such software subroutines (e.g., associated with operation of the on-board video compression circuitry 150) may be provided to application program developers to integrate into application code, which would then be downloaded into the memory 120 and executed by the CPU 110.

The exemplary PC motherboard 100 was presented to provide specific illustrations of various generally broader aspects of the present invention. Accordingly, the scope of various aspects of the present invention should not be limited by characteristics of the exemplary PC motherboard 100.

FIG. 2 is a block diagram illustrating a personal computer motherboard 200, in accordance with various aspects of the present invention. The exemplary motherboard 200 may, for example and without limitation, share various characteristics with the exemplary motherboard 100 illustrated in FIG. 1 and discussed previously.

The personal computer (“PC”) motherboard 200 may comprise any of a large variety of components, a portion of which are illustrated in FIG. 2. For example and without limitation, the PC motherboard 200 may comprise a CPU 210. The PC motherboard 200 may also comprise a Memory 220, which may, for example, be communicatively coupled to the CPU 210 by a system bus 230. The PC motherboard 200 may also comprise a general communication interface 270 communicatively coupled to the CPU 210 (e.g., through a secondary bus 293 and/or the system bus 230). The PC motherboard 200 may further comprise an expansion interface 260 communicatively coupled to the CPU 210 (e.g., through a secondary bus 293 and/or the system bus 230). The PC motherboard 200 may also comprise a video input interface 240 and on-board video compression circuitry 250 communicatively coupled to the CPU 210 (e.g., through a secondary bus 291 and/or the system bus 230).

The CPU 210 may comprise any of a variety of central processing units (e.g., presently available or to be available in the future). The CPU 210 may, for example and without limitation, share various characteristics with the CPU 110 of the exemplary PC motherboard 100 illustrated in FIG. 1. For example, the CPU 210 may comprise any of a variety of microprocessor types. The CPU 210 generally controls operation of the PC motherboard 200 and thus, the personal computer into which the PC motherboard 200 is installed. The CPU 210 may generally interface with other components of the PC motherboard 200 through the system bus 230 (and/or other buses).

The memory 220 may comprise characteristics of any of a variety of memory types. The memory 220 may, for example and without limitation, share various characteristics with the memory 120 of the exemplary PC motherboard 100 illustrated in FIG. 1. For example and without limitation, the memory 220 may comprise volatile or non-volatile memory. The memory 220 may, for example, comprise static RAM and/or dynamic RAM. The memory 220 may, for example, comprise firmware 223. The memory 220 may also, for example, comprise one or more memory caches 221 (e.g., utilized by the CPU 210 for instruction and/or data caching). Though the memory 220 is illustrated in FIG. 2 as one block, it should be recognized that the memory 220 might comprise any, or any combination, of a variety of memory devices or memory device types, which may be integrated into a single component or a plurality of independent components.

The memory 220 may generally be utilized by the CPU 210 to store instructions that the CPU 210 may execute. For example, the memory 220 may store instructions that the CPU 210 may execute to process video and/or audio information. The CPU 210 may, for example, manage the loading of instructions into the memory 220 to achieve efficient instruction execution. The CPU 210 may also utilize the memory 220 to store data being processed or the results of data processing. Such data may represent any of a variety of data types, including without limitation, video data and audio data.

As illustrated in FIG. 2, a system bus 230 may communicatively couple the memory 220 (or portions thereof) and the CPU 210. The system bus 230 may, in turn, be communicatively coupled to one or more other buses (e.g., secondary or tertiary buses). Three exemplary secondary (or tertiary) buses 291, 293 and 296 are illustrated in FIG. 2. Such communicative coupling between buses may, for example, be performed using various bus bridging circuitry.

For example, a first secondary bus 291 may be communicatively coupled to the system bus 230 through a first system bus bridge 290. Alternatively, for example, the first secondary bus 291 may be directly coupled to the system bus 230. Also for example, a second secondary bus 293 may be communicatively coupled to the system bus 230 through a second system bus bridge 292. For example and without limitation, the second system bus bridge 292 may comprise characteristics of a system bus/PCI bus bridge. Additionally for example, a third secondary bus 296 may be communicatively coupled to the system bus 230 through a third system bus bridge 294. The third system bus bridge 294 may, for example and without limitation, comprise characteristics of a system bus/EISA bus bridge.

The video input interface 240 may comprise one or more various modules adapted to receive any of a variety of types of video signals. The video input interface 240 may, for example and without limitation, share various characteristics with the video input interface 140 of the exemplary motherboard 100 illustrated in FIG. 1.

The video input interface 240 may, for example, comprise a composite video input module 241 adapted to receive one or more color composite video signals. The composite video input module 241 may, for example, comprise an NTSC module 242 adapted to receive an NTSC video signal. The composite video input module 241 may also, for example, comprise a PAL module 243 and/or a SECAM module 244 adapted to receive PAL and SECAM video signals, respectively. The composite video input module 241 may additionally, for example, comprise various modules adapted to receive monochrome video signals (e.g., a RS-170 module 245 and/or a CCRR module 246).

The video input interface 240 may also, for example, comprise a camera video input module 249 adapted to receive video signals from any of a variety of cameras. Such cameras may, for example, comprise characteristics of analog and/or digital video cameras. Video signals associated with such cameras may, for example, comprise characteristics associated with any of a variety of video standards and/or camera vendor-specific (e.g., propriety) signal definitions. Such cameras may, for example, comprise characteristics of general-purpose video cameras, web-cams, surveillance cameras, etc. The video input interface 240 may further, for example, comprise a component video input module 247 adapted to receive component video signals. Such component video signals may, for example, comprise RGB or YCrCb video components.

The video input interface 240 may additionally, for example, comprise a compressed video input module 248 adapted to receive compressed video signals. For example and without limitation, such compressed video signals may comprise characteristics associated with various video compression standards (e.g., MPEG-1, MPEG-2, MPEG-4, MPEG-4 part 10, various non-MPEG compression standards or techniques, etc.). The compressed video input module 248 may, for example, be adapted to communicate information in accordance with the various transport layers defined for various compression standards. In a non-limiting exemplary scenario, a compressed video signal (e.g., compressed in accordance with a first compression scheme) may be received by the compressed video input module 248, decoded by decoding circuitry of the PC motherboard 200, and recompressed (e.g., in accordance with a second compression scheme) by the on-board video compression circuitry 250 to be discussed below.

Note that the video input interface 240 may be adapted to receive any number of video signals (e.g., one, two, four or N video signals). In other words, the video input interface 240 may comprise any of, any combination of, or any number of the previously discussed modules. Note also that video signals may also be received by the general communication interface 270, which will be discussed later.

The previously discussed exemplary video signals and video input modules are merely exemplary. Accordingly, the scope of various aspects of the present invention should not be limited by characteristics of any particular video standard or signal type or by characteristics of any particular hardware and/or software utilized to receive such signals.

The on-board video compression circuitry 250 may, for example, comprise electronic hardware dedicated to the compression of video information. Such dedicated compression hardware may, for example, also comprise accompanying firmware and/or software. The on-board video compression circuitry 250 may comprise any of a variety of video compression circuitry, including but not limited to, various types of moving picture encoding circuitry. For example, the on-board video compression circuitry 250 may comprise one or more MPEG-2 and/or MPEG-4 compression circuits. Also for example, the on-board video compression circuitry 250 may comprise one or more MPEG-4 part 10 (or H.264) compression circuits. In a non-limiting exemplary scenario where the on-board video compression circuitry 250 comprises a plurality of such compression circuits, the on-board video compression circuitry 250 may be adapted to utilize at least a portion of such compression circuits to concurrently (or simultaneously) compress a plurality of video signals received by the video input interface 240.

The on-board video compression circuitry 250 may, for example, be adapted to perform real-time compression of video information (e.g., as received by the video input interface 240). For example and without limitation, the on-board video compression circuitry 250 may be adapted to perform such video compression at rates not generally achievable by the CPU 210 executing software instructions (e.g., while also performing general CPU functions).

In one non-limiting exemplary scenario, the on-board video compression circuitry 250 may be configurable to perform video compression in accordance with any one or more of a variety of video compression techniques. For example, the on-board video compression circuit 250 may comprise memory 251 (or may utilize memory external to the video compression circuitry 250) to store information that governs operation of the on-board video compression circuitry 250. Such information may, for example, comprise information indicating which video compression technique to perform and/or information indicating how particular components of the video compression circuitry 250 (e.g., encoders, filters, A/D converters, quantizers, interpolators, etc.) are to perform their respective processing functions.

The on-board video compression circuitry 250 may be communicatively coupled to the CPU 210. Such communicative coupling may be direct or indirect. For example and without limitation, the on-board video compression circuitry 250 may be directly coupled to the system bus 230. Also for example, the on-board video compression circuitry 250 may be directly coupled to the first secondary bus 291 (e.g., a bus adapted to communicate video or multi-media information), which in turn, is coupled to the system bus 230 through the first system bus bridge 290.

The expansion interface 260 may be adapted to interface with any of a variety of motherboard interface cards. For example and without limitation, the expansion interface 260 may comprise one or more expansion slots 261 and may be adapted to interface with a video card 265 that is adapted to (e.g., among other things) receive and compress a video signal. Such a video card may, for example, comprise any of a variety video compression circuitry (e.g., a video input interface 266 and a video compressor 267).

In an exemplary scenario, where the expansion interface 260 is interfacing with a video card 265, the memory 220 (or other memory of the motherboard) may store at least one software module that, when executed by a processor (e.g., the CPU 210), results in the processor managing the on-board video compression circuitry 250 and the video card 265. For example, in the exemplary scenario, the processor may execute the software module(s) and thereby coordinate simultaneous use of the on-board video compression circuitry 250 and the video card. Also for example, in the exemplary scenario, the processor may execute the software module(s) and thereby select between (and/or time multiplex) video information associated with the on-board video compression circuit 250 and video information associated with the video card 265. Further for example, in the exemplary scenario, the processor may execute the software module(s) and thereby select between utilizing one or the other of the on-board video compression circuitry 250 and the video card 265. Though the exemplary scenario comprises utilizing the on-board video compression circuitry 250 and the video card 265 with a processor executing software instructions, such utilization (or various portions thereof) may alternatively be performed by dedicated hardware.

The expansion interface 260 may be communicatively coupled to the CPU 210. Such communicative coupling may be direct or indirect. For example and without limitation, the expansion interface 260 may be directly coupled to the system bus 230. Also for example, the expansion interface 260 may be directly coupled to a secondary bus 293 (e.g., a Peripheral Component Interconnect (“PCI”) bus or other peripheral communication bus), which in turn is coupled to the system bus 230 through a second system bus bridge 292.

The general communication interface 270 may generally comprise various hardware and/or software modules adapted to communicate with devices external to the PC motherboard 200. For example and without limitation, the general communication interface 270 may comprise one or more user interface modules 271 adapted to perform general user interface functions. The general communication interface 270 may also, for example, comprise one or more serial interface modules 272 and/or parallel interface modules 273. Additionally for example, the general communication interface 270 may comprise one or more audio interface modules 274 and/or video interface modules 275. Further for example, the general communication interface 270 may comprise any of a variety of generally computer communication modules (e.g., a fire wire module 276 and/or a USB module 277). Still further for example, the general communication interface 270 may comprise one or more modules 278 adapted to communicate with a removable memory card or memory stick.

The general communication interface 270 may, for example, comprise one or more modem modules 280 adapted to communicate between the motherboard 200 and a device external to the motherboard 200 via a modem (e.g., an internal or external modem). Such a modem module 280 may, for example, comprise characteristics of a television cable modem or telephone network modem. Also for example, the general communication interface 270 may comprise one or more modules adapted to communicate over any of a variety of computer communication networks utilizing any of a variety of computer communication network protocols. For example, the general communication interface 270 may comprise an Ethernet module 279 (or a Token Ring module). Also for example, the general communication interface 270 may comprise one or more modules adapted to communicate over any of a variety of wireless computer communication networks. For example, the general communication interface 270 may comprise a WLAN module 281 and/or a WPAN module 282. Further for example, the general communication interface 270 may comprise one or more module(s) adapted to communicate information directly to various external devices (e.g., a video display device, television, television set top box, satellite receiver, etc.).

The general communication interface 270 (or a portion thereof) may be adapted to communicate compressed video information (e.g., from the on-board video compression circuitry 250) to a device external to the PC motherboard 200. Such communication may, for example, be governed by the on-board video compression circuitry 250 and/or the CPU 210. Such communication may, for example, occur utilizing any of the exemplary interface modules presented above and many others that were not explicitly mentioned. For example, such communication may occur utilizing a modem and/or modem interface 280 of the general communication interface 270 (e.g., a cable modem or telephone modem). Also for example, such communication may occur utilizing any of a variety of computer network interface modules (e.g., Ethernet 279, Token Ring, WLAN 281, WPAN 282, etc.). Further for example, such communication may occur utilizing one or more modules adapted to communicate video information directly to a video display system, television, television set top box, satellite receiver, etc.).

The general communication interface 270 (or a portion thereof, for example, a video interface module 275) may be adapted to communicate non-compressed video information to one or more video devices or video display systems external to the PC motherboard 200. For example, the general communication interface 270 (e.g., the video output module 275) may be adapted to communicate a received video signal (e.g., as received by the video input interface 240) to a device external to the PC motherboard 200. Such communication may, for example, be generally governed by the CPU 210, or alternatively, the video compression circuitry 250 and/or the video input interface 240. The received video signal (or a signal representative thereof) may, for example, be communicated to the external device while the video compression circuitry 250 is compressing the received video signal.

The general communication interface 270 (or a portion thereof, for example, a video interface module 275) may also be adapted to communicate compressed video information (e.g., from the on-board video compression circuitry 250) to one or more video devices or video display systems external to the PC motherboard 200. Such compressed video information may, for example, correspond exactly to compressed video information formed by the on-board video compression circuitry 250 or may correspond approximately to such compressed video information. Such compressed video information may also, for example, correspond to compressed video information that might be received by the video input interface 240.

In communicating video information, the general communication interface 270 (or a portion thereof, for example, a video interface module 275) may communicate analog and/or digital video signals. Such signals may comprise characteristics of any of a variety of video signals, including without limitation, composite color, monochrome or component video signals. Further for example, the general communication interface 270 may be adapted to communicate one or any number of such signals.

As mentioned previously, the general communication interface 270 may, for example, comprise various audio interface modules 274. For example, the general communication interface 270 (or a portion thereof, for example, an audio interface module 274) may be adapted to receive an audio signal. The audio signal may, for example, correspond to a video signal received by the video input interface 240 or a video interface module 275 of the general communication interface 270. Various modules of the PC motherboard 200 may, for example, be adapted to compress received audio information. Such modules may, for example, comprise hardware and/or software (e.g., software executed by the CPU 210). Also for example, various modules of the PC motherboard 200 may be adapted to synchronize received analog information (or signals) with received video information (or signals). In a non-limiting exemplary scenario, various modules of the PC motherboard 200 may be adapted to receive, compress and synchronize video and audio signals associated with a particular multimedia program.

The PC motherboard 200 may comprise a video output processor 258 and video output interface 259. The video output processor 258 may, for example, be adapted to communicate video information (e.g., from the on-board video compression circuitry 250, video input interface 240 or CPU 210) to a device external to the PC motherboard 200 (e.g., through the video output interface 259). Such communication may, for example, be governed by the on-board video compression circuitry 250 and/or the CPU 210. As mentioned above with regard to the general communication interface 270, the communication of such information may be implemented utilizing any of variety of communication circuitry.

The video output interface 259 may comprise characteristics of any of a variety of video output interfaces (and general communication interfaces). For example, the video output interface 259 may comprise characteristics of a modem and/or modem interface (e.g., a cable modem or telephone modem). Also for example, the video output interface 259 may comprise at least one module adapted to communicate over a computer network (e.g., utilizing Ethernet, Token Ring, WLAN, WPAN, etc.). Further for example, the video output interface 259 may comprise at least one module adapted to communicate video information directly to a video display system, television, television set top box, satellite receiver, etc.).

The video output interface 259 may, for example, be generally adapted to communicate with a video display system. Various modules (e.g., the on-board video compression circuitry 250, video output processor 258 or the CPU 210) may then utilize the video output interface 259 to communicate video information to a video display system. The video output interface 259 may, for example and without limitation, share various characteristics with the general communication interface 270 (e.g., the video interface module 275) discussed previously.

In a non-limiting exemplary scenario, the video output processor 258 (or other component of the PC motherboard 200) may utilize the video output interface 259 to communicate compressed video information to a video display system. Such compressed video information may, for example, comprise compressed video information formed by the on-board video compression circuitry 250 or information indicative of such compressed video information (e.g., a subset of such compressed information or further compressed version of such compressed video information). Such compressed video information may also, for example, correspond to compressed video information received by the video input interface 240.

In another non-limiting exemplary scenario, the video output processor 258 (or other component of the PC motherboard 200) may utilize the video output interface 259 to communicate non-compressed video information to a video display system. Such non-compressed video information may, for example, comprise a video signal received by the video input interface 240. For example, such a received video signal may be communicated through the video output interface 259 concurrently with the compression of such a received video signal by the on-board video compression circuitry 250. Also for example, such non-compressed video information may comprise a decompressed representation of video information compressed by the on-board video compression circuitry 250.

The video output interface 259 may, for example, be adapted to output any of a variety of types of video signals. For example, the video output interface 259 may be adapted to output an analog and/or digital video signal. Also for example, the video output interface 259 may be adapted to output a composite video signal or a component video signal. Note that the video output interface 259 may be adapted to communicate one or more than one video signals (e.g., concurrently).

The PC motherboard 200 may comprise an audio input interface 215 and on-board audio compression circuitry 216. The audio input interface 215 may be adapted to receive any of a variety of audio signals, and the on-board audio compression circuitry 216 may be adapted to compress such received audio signals. In a non-limiting exemplary scenario, audio information received through the audio input interface 215 may correspond to video information received through the video input interface 240. In such an exemplary scenario, the PC motherboard 200 may comprise at least one module (e.g., the on-board video compression circuitry 250, on-board audio compression circuitry 216 or CPU 210) adapted to synchronize (or combine) compressed video information from the on-board video compression circuitry 250 and compressed audio information from the on-board audio compression circuitry 216. Though the exemplary PC motherboard 200 is illustrated with on-board (e.g., dedicated) audio compression circuitry 216, audio compression may alternatively be performed by a processor (e.g., the CPU 210) executing software instructions.

The PC motherboard 200 may also comprise an audio output processor 217 and audio output interface 218. Generally analogous to the video output processor 258 and video output interface 259 discussed above, the audio output processor 217 and/or audio output interface 218 may be adapted to output compressed and/or non-compressed audio information. Such audio information may, for example, correspond to an audio signal currently being compressed by the on-board audio compression circuitry 216, an audio signal previously compressed by the on-board audio compression circuitry 216, or an audio signal going to be compressed by the on-board audio compression circuitry 216.

The PC motherboard 200 may further comprise an external memory interface 285 that is adapted to store information (e.g., compressed video and/or audio information) in a memory device external to the PC motherboard 200. The external memory interface 285 may be adapted to interface with any of a variety of external memory devices. For example and without limitation, the external memory interface 285 may be adapted to interface with a hard drive, CD drive or DVD drive. Also for example, the external memory interface 285 may be adapted to interface with any of a variety of removable memory media (e.g., memory cards, memory sticks, etc.). Further for example, the external memory interface 285 may be adapted to interface with external memory utilizing direct memory access (“DMA”). In a non-limiting exemplary scenario, the on-board video compression circuitry 250 (or other circuitry of the PC motherboard 200, for example, the CPU 210) may utilize the external memory interface 285 to store compressed video and/or audio information in an external memory device.

The PC motherboard 200 may comprise any of a variety of additional hardware and/or software modules. For example and without limitation, the PC motherboard 200 may comprise a moving picture software module stored in the memory 220, where the moving picture software, when executed by a processor (e.g., the CPU 210), causes the processor to form a moving picture file (e.g., an mpeg file or other file) from compressed video information. The PC motherboard 200 may also, for example, comprise compression control information stored in the memory 220 (or, for example, a memory 251 of the on-board video compression circuitry 250), where such compression control information controls the manner in which the on-board video compression circuitry 250 compresses received video information.

In a non-limiting exemplary scenario in which the on-board video compression circuitry 250 is capable of compressing received video information in accordance with any of a plurality of video compression standards or techniques, the compression control information may comprise information indicating which of the plurality of video compression standards and/or techniques the on-board compression circuitry 250 is to perform. Such information may, for example, be stored in volatile or non-volatile memory.

In another non-limiting exemplary scenario, the PC motherboard 200 may comprise a plurality of software subroutines stored in the memory 220, where such subroutines are accessible to programmers that provide video applications for the PC motherboard 200. For example, the plurality of software subroutines may serve as an interface between application software executing on the CPU 210 and the on-board video compression circuitry 250. Such subroutines may, for example, comprise an application programmer interface. Such subroutines may, for example, generally reside on the PC motherboard 200 or may, for example, be loaded into the memory 220 from another memory (e.g., a hard drive) when needed. In another exemplary scenario, a library of such software subroutines (e.g., associated with operation of the on-board video compression circuitry 250) may be provided to application program developers to integrate into application code, which would then be downloaded into the memory 220 and executed by the CPU 210.

The exemplary PC motherboard 200 was presented to provide specific illustrations of various generally broader aspects of the present invention. Accordingly, the scope of various aspects of the present invention should not be limited by characteristics of the exemplary PC motherboard 200.

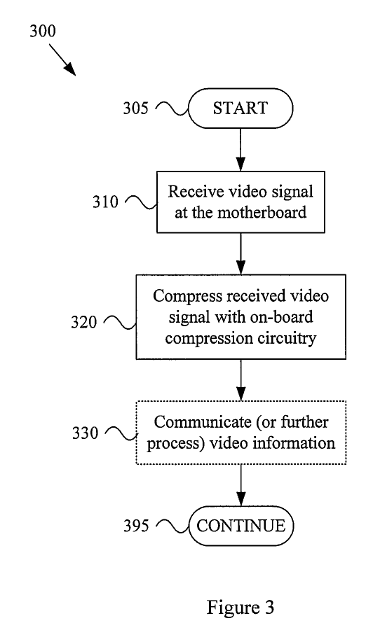

FIG. 3 is a flow diagram illustrating an exemplary method 300, in a personal computer motherboard, for performing video compression, in accordance with various aspects of the present invention. The exemplary method 300 may, for example and without limitation, share various functional characteristics with the exemplary PC motherboards 100, 200 illustrated in FIGS. 1-2 and discussed previously.

The exemplary method 300 may be implemented in any of a variety of personal computer (“PC”) motherboards, which may, in turn, be utilized in any of a number of types of personal computer systems. Such systems may, for example, be based on any of a variety of microprocessors and/or any of a variety of motherboard chipsets. Such systems may, for example, be produced by any of a variety of companies in the business or producing such systems. A PC motherboard implementing the exemplary method 300 may comprise any of a variety of components. Various non-limiting examples of such components were introduced in the previous discussion of FIGS. 1 and 2.

The exemplary method 300 may begin executing at step 305. The exemplary method 300 (and other methods discussed herein) may begin executing for any of a variety of reasons. For example and without limitation, the exemplary method 300 may begin executing in response to a user command to begin or a command received from another system. Also for example, the exemplary method 300 may begin executing in response to the arrival of a video signal at a motherboard implementing the method 300. Further for example, the exemplary method 300 may begin executing in response to a detected operating condition (e.g., a timer expiration, detection of a video event to record, etc.).

The exemplary method 300 may, at step 310, comprise receiving a video signal (or video information) through a video input interface of the PC motherboard. Such a video input interface may, for example and without limitation, share various characteristics with the video input interfaces 140, 240, 275 of the exemplary PC motherboards 100, 200 illustrated in FIGS. 1-2 and discussed previously.

Step 310 may comprise receiving any of a variety of types of video signals through the video input interface. For example and without limitation, step 310 may comprise receiving one or more color composite video signals (e.g., NTSC, PAL or SECAM signals). Also for example, the step 310 may comprise receiving one or more monochrome video signals (e.g., RS-170 or CCRR signals). Additionally, for example, step 310 may comprise receiving one or more signals from any of a variety of video cameras (e.g., standard and/or proprietary signal types). Further for example, step 310 may comprise receiving one or more component video signals.

Step 310 may, for example, comprise receiving compressed video signals. For example and without limitation, such compressed video signals may comprise characteristics associated with various video compression standards (e.g., MPEG-1, MPEG-2, MPEG-4, MPEG-4 part 10, various non-MPEG compression standards or techniques, etc.). Step 310 may, in various exemplary scenarios, comprise implementing various respective transport layers associated with various respective video compression standards. Note that step 310 may comprise receiving any number of video signals (e.g., one, two, four or N video signals), which may be received serially or concurrently.

The exemplary method 300 may, at step 320, comprise producing compressed video information by utilizing a video compression circuit on-board the PC motherboard to compress the received video signal. Such an on-board video compression circuit may, for example and without limitation, share various characteristics with the on-board video compression circuitry 150, 250 of the exemplary PC motherboards 100, 200 illustrated in FIGS. 1-2 and discussed previously.

For example, the on-board video compression circuitry may comprise electronic hardware dedicated to the compression of video information. Such dedicated compression hardware may, for example, also comprise accompanying firmware and/or software. The on-board video compression circuitry may comprise any of a variety of video compression circuitry, including but not limited to, various types of moving picture encoding circuitry. For example, the on-board video compression circuitry may comprise one or more MPEG-2 and/or MPEG-4 compression circuits. Also for example, the on-board video compression circuitry may comprise one or more MPEG-4 part 10 (or H.264) compression circuits. In a non-limiting exemplary scenario where the on-board video compression circuitry comprises a plurality of such compression circuits, step 320 may comprise utilizing at least a portion of such compression circuits to concurrently (or simultaneously) compress a plurality of video signals (e.g., as may be received at step 310).

Step 320 may, for example, comprise compressing the received video signal in real-time. Step 320 may, for example, comprise compressing the received video information at rates not generally achievable by the CPU of the motherboard executing software instructions (e.g., while also performing general CPU functions).

In one non-limiting exemplary scenario, the on-board video compression circuitry may be configurable to perform video compression in accordance with any one or more of a variety of video compression techniques. In such a non-limiting exemplary scenario, step 320 may comprise storing information in memory of the PC motherboard, where the information governs operation of the on-board video compression circuitry. Such information may, for example, comprise information indicating which video compression technique to perform and/or information indicating how particular components of the on-board video compression circuitry (e.g., encoders, filters, A/D converters, quantizers, interpolators, etc.) are to perform their respective processing functions.

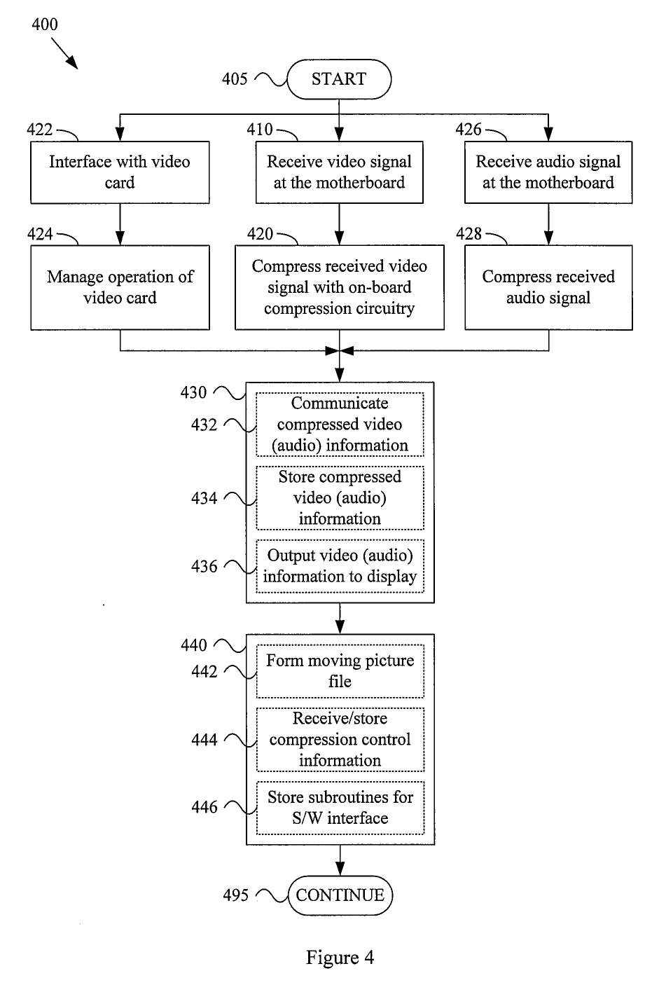

The exemplary method 300 may, at step 330, comprise communicating (or further processing) video information (e.g., the compressed video information formed at step 320 and/or the non-compressed video information received at step 310). Various examples of such further processing were discussed previously with regard to the exemplary PC motherboards 100, 200 illustrated in FIGS. 1-2. Various examples of such further processing will also be discussed later with regard to the exemplary method 400 illustrated in FIG. 4.

The exemplary method 300 was presented to provide specific illustrations of various generally broader aspects of the present invention. Accordingly, the scope of various aspects of the present invention should not be limited by specific characteristics of the exemplary method 300.

FIG. 4 is a flow diagram illustrating a method 400, in a personal computer motherboard, for performing video compression, in accordance with various aspects of the present invention. The exemplary method 400 may, for example and without limitation, share various characteristics with the exemplary method 300 illustrated in FIG. 3. Also for example, the exemplary method 400 may share various functional characteristics with the exemplary PC motherboards 100, 200 illustrated in FIGS. 1-2 and discussed previously.

The exemplary method 400 may, at step 410, comprise receiving a video signal (or video information) through a video input interface of the PC motherboard. Step 410 may, for example and without limitation, share various characteristics with step 310 of the exemplary method 300 illustrated in FIG. 3 and discussed previously.

The exemplary method 400 may, at step 420, comprise producing compressed video information by utilizing a video compression circuit on-board the PC motherboard to compress the received video signal. Step 420 may, for example and without limitation, share various characteristics with step 320 of the exemplary method 300 illustrated in FIG. 3 and discussed previously.

The exemplary method 400 may, at step 422, comprise interfacing with a video card that is communicatively coupled to the PC motherboard through an expansion interface, where the video card is adapted to receive and compress a video signal. Step 422 may, for example and without limitation, share various functional characteristics with the video expansion interfaces 160, 260 of the exemplary systems 100, 200 illustrated in FIGS. 1-2 and discussed previously.

For example, step 422 may comprise interfacing with any of a variety of motherboard expansion cards. For example, step 422 may comprise utilizing one or more expansion slots of the PC motherboard and may comprise interfacing with a video card that is mounted to one of such expansion slots and adapted to (e.g., among other things) receive and compress a video signal. Such a video card may, for example, comprise any of a variety video compression circuitry (e.g., a video input interface and a video compressor).

The exemplary method 400 may, at step 424, comprise managing operation of the video card (e.g., the video card being interfaced with at step 422). In a non-limiting exemplary scenario where step 420 comprises compressing a video signal utilizing on-board video compression circuitry and step 422 comprises interfacing with a video card coupled to the PC motherboard, step 424 (and/or step 420) may (e.g., by executing a software module stored on the PC motherboard) comprise managing both the on-board video compression circuitry and the video card. For example, in the exemplary scenario, step 424 may comprise coordinating simultaneous use of the on-board video compression circuitry and the video card. Also for example, in the exemplary scenario, step 424 may (e.g., by executing a software module stored on the PC motherboard) comprise selecting between (and/or time multiplexing) video information associated with the on-board video compression circuitry and video information associated with the video card. Further for example, in the exemplary scenario, step 424 may (e.g., by executing a software module stored on the PC motherboard) comprise selecting between utilizing one or the other of the on-board video compression circuitry and the video card. Though the exemplary scenario mentioned executing software stored on the PC motherboard, step 424 (or various portions thereof) may also be implemented by hardware (e.g., hardware on-board the PC motherboard).

The exemplary method 400 may, at step 426, comprise receiving an audio signal through an audio input interface. Step 426 may, for example and without limitation, share various functional characteristics with the audio input interface 215 and general communication interface 270 (e.g., the audio interface module 274) of the exemplary PC motherboard 200 illustrated in FIG. 2 and discussed previously.

For example, step 426 may comprise receiving any of a variety of types of audio signals. Such audio signals may, for example, correspond to video information received at step 410 and/or step 422. Alternatively, for example, such audio signals may be independent of received video signals.

The exemplary method 400 may, at step 428, comprise compressing the audio signal(s) received at step 426. Step 428 may, for example and without limitation, share various characteristics with the audio compression circuitry 216 of the exemplary motherboard 200 illustrated in FIG. 2 and discussed previously.

For example, step 428 may comprise compressing the audio signal(s) in accordance with any of a variety of audio compression standards, including those audio compression standards that are integrated with various video compression standards. Step 428 may, for example, comprise compressing the received audio information utilizing dedicated audio compression circuitry disposed on-board the motherboard. Alternatively for example, step 428 may comprise compressing the received audio information with a processor (e.g., the PC motherboard CPU) executing software instructions (e.g., stored in memory of the PC motherboard).

In a non-limiting exemplary scenario, where audio information received at step 426 corresponds to video information received at step 410 and/or step 422, the exemplary method 400 may (e.g., at step 428 or other steps) comprise synchronizing (or combining) compressed audio information (e.g., from step 428) and compressed video information (e.g., from step 420 and/or step 424).

Note that in various non-limiting exemplary scenarios, the three branches illustrated in the flow diagram of the method 400 (i.e., a first flow path including steps 422 and 424, a second flow path including steps 410 and 420, and a third flow path including steps 426 and 428) may be executing concurrently or serially. For example and without limitation, while steps 410 and 420 are receiving and compressing video information, steps 426 and 428 may be receiving and compressing audio information (e.g., audio information corresponding to the video information).

The exemplary method 400 may, at step 430, comprise performing communicating video and/or audio information (e.g., the compressed video information formed at steps 420 or 424, the video information received at steps 410 or 422, the compressed audio information formed at step 428 and/or the audio information received at step 426). Step 430 may, for example and without limitation, share various characteristics with step 330 of the exemplary method 300 illustrated in FIG. 3. Also for example, step 430 may share various functional characteristics with the exemplary PC motherboards 100, 200 illustrated in FIGS. 1-2 and discussed previously (e.g., the general communication interfaces 170, 270, the video output processor 258, the video output interface 259, the audio output processor 217 and the audio output interface 218).

Step 430 is illustrated with non-limiting exemplary communication activities. For example, step 432 may comprise communicating the compressed video information through a communication interface of the PC motherboard to a device external to the PC motherboard. Step 432 may, for example, comprise utilizing general-purpose or dedicated interface components of the PC motherboard to perform such communication. For example and without limitation, step 432 may comprise utilizing various audio and/or video interface modules to perform such communication. Also for example, step 432 may comprise utilizing a modem and/or modem interface of the PC motherboard to perform such communication.

Step 432 may comprise communicating the compressed video (or audio) information through any of a variety of communication networks. For example and without limitation, step 432 may comprise communicating the compressed information through a computer network, a television network or telephone network. Also for example, step 432 may comprise communicating the compressed video (or audio) information directly to a television or television set top box. Further for example, step 430 may comprise communicating the compressed video (or audio) information directly to a video display.

Step 434 may comprise communicating the compressed video (or audio) information to a storage device for storage. For example, such a storage device may be on-board the PC motherboard or external to the PC motherboard. Such a storage device may, for example, comprise a hard drive or a drive associated with a removable storage medium (e.g., a DVD, CD, thumb drive module, memory stick, memory card, diskette, etc.). Step 434 may also, for example, comprise communicating the compressed video (or audio) information to a memory device utilizing direct memory access.

Step 436 may, for example, comprise communicating non-compressed video (or audio) information to a device external to the PC motherboard. For example and without limitation, step 436 may comprise communicating a received video (or audio) signal (e.g., as might be received at steps 410, 422 or 426) through a communication interface to a device external to the PC motherboard. In a non-limiting exemplary scenario, step 436 may comprise communicating a received video (or audio) signal that is also (e.g., concurrently) being compressed at steps 420, 424 or 428.

Step 436 (or, e.g., step 432) may comprise communicating non-compressed (or compressed) video information to a video display system through a video output interface of the PC motherboard. Such a signal may comprise various signal characteristics. For example, such a signal may comprise characteristics of an analog or digital video signal. Such a signal may comprise characteristics of component or composite video signals (e.g., color or monochrome).

Note that any of the steps of the exemplary method 400 may be readily extended to include receiving, compressing, communicating, or further processing a plurality of received video and/or audio signals simultaneously. In a non-limiting exemplary scenario, step 410 may comprise receiving a plurality of video signals at the motherboard, step 420 may comprise simultaneously compressing the plurality of received video signals, and step 430 may comprise communicating compressed or non-compressed video signals associated with the plurality of received video signals.

The exemplary method 400 may, at step 440, comprise performing additional video processing activities (e.g., related to received or compressed video signals). Step 440 may, for example and without limitation, share various functional characteristics with the exemplary PC motherboards 100, 200 illustrated in FIGS. 1-2 and discussed previously.

The exemplary step 440 is illustrated with a non-limiting set of examples in sub-steps 442, 444 and 446. Step 442 may, for example, comprise forming a moving picture file from the compressed video information (e.g., as might be received at steps 422 or 420 or as formed at steps 424 or 420). Step 442 may, for example and without limitation, be performed by executing a software module stored in memory of the PC motherboard.

Step 444 may comprise receiving and/or storing compression control information in the PC motherboard (e.g., in non-volatile memory or volatile memory), where compression control information controls a manner in which step 420 compresses video information. In such an exemplary scenario, step 420 may then comprise compressing the video information in accordance with such control information. Such control information may, for example, comprise information indicating which of a plurality of video compression techniques or standards that step 420 is to perform. Also for example, such control information may comprise information indicating how particular components of the on-board video compression circuitry are to function (e.g., components such as, for example, encoders, filters, A/D converters, quantizers, interpolators, etc.).

Step 446 may, for example, comprise storing in the PC motherboard (or executing in the PC motherboard) a plurality of software subroutines (or drivers), where such subroutines are accessible to programmers that provide video application for the PC motherboard. For example, the plurality of software subroutines may serve as an interface between application software executing on the PC motherboard CPU and the on-board video compression circuitry. Such subroutines may, for example, comprise an application programmer interface. Such subroutines may, for example, generally reside on the PC motherboard 200 or may, for example, be loaded into the memory 220 from another memory (e.g., a hard drive) when needed. In another exemplary scenario, a library of such software subroutines (e.g., associated with operation of the on-board video compression circuitry) may be provided to application program developers to integrate into application code, which would then be downloaded into the PC motherboard memory and executed by the PC motherboard CPU.

The exemplary method 400 may, at step 495, comprise performing any of a variety of additional processing activities. For example and without limitation, step 495 may comprise looping flow of the exemplary method 400 back up to any of the previous steps (e.g., in response to real-time conditions or automatically). Also for example, step 495 may comprise performing any of a variety of user interface functions or audio/video I/O functions. Further for example, step 495 may comprise communicating audio or video information with any of a variety of sources and receivers of such information.

The exemplary method 400 was presented to provide specific illustrations of various generally broader aspects of the present invention. Accordingly, the scope of various aspects of the present invention should not be limited by specific characteristics of the exemplary method 400.

In summary, various aspects of the present invention provide a personal computer motherboard with on-board video compression capability and a method in a personal computer motherboard for compressing video information utilizing on-board video compression circuitry. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A personal computer (PC) motherboard comprising:
a CPU disposed on the PC motherboard;
memory disposed on the PC motherboard;
a video input interface disposed on the PC motherboard and adapted to receive at least one video signal from a source external to the PC motherboard; and
at least one module disposed on the PC motherboard and comprising an on-board video compression circuit, wherein the at least one module is adapted to:
receive a video signal from the video input interface; and
utilize the on-board video compression circuit to compress the received video signal to produce compressed video information.

2. The PC motherboard of claim 1, further comprising a first expansion interface adapted to interface with at least a video card that is adapted to receive and compress a video signal.

3. The PC motherboard of claim 2, further comprising at least a second module adapted to:
manage the at least one module; and
manage a video card communicatively coupled to the first expansion interface.

4. The PC motherboard of claim 2, further comprising at least a second module adapted to coordinate simultaneous use of the at least one module and a video card communicatively coupled to the first expansion interface.

5. The PC motherboard of claim 1, further comprising a communication interface, and wherein the at least one module is adapted to communicate the compressed video information to a device external to the PC motherboard through the communication interface.

6. The PC motherboard of claim 1, further comprising a communication interface, and wherein the at least one module is adapted to communicate the received video signal to a device external to the PC motherboard through the communication interface.

7. The PC motherboard of claim 6, wherein the at least one module is adapted to communicate the received video signal to a device external to the PC motherboard through the communication interface while the at least one module is utilizing the on-board video compression circuit to compress the received video signal.

8. The PC motherboard of claim 1, wherein the video input interface comprises at least one module adapted to receive a video signal from a video camera.

9. The PC motherboard of claim 1, further comprising a memory interface, and wherein the at least one module is adapted to store the compressed video information in a memory device external to the PC motherboard through the memory interface.

10. The PC motherboard of claim 1, further comprising a video output interface adapted to communicate with a video display system, and wherein the at least one module is adapted to communicate video information to a video display system through the video output interface.

11. The PC motherboard of claim 1, further comprising an audio input interface, and wherein the at least one module is adapted to:
receive an audio signal through the audio input interface; and
compress the received audio signal to produce compressed audio information.

12. The PC motherboard of claim 11, wherein the at least one module is adapted to synchronize the compressed video information and the compressed audio information.

13. The PC motherboard of claim 1, further comprising compression control information stored in the memory, wherein the compression control information controls a manner in which the on-board video compression circuit compresses the received video signal.

14. The PC motherboard of claim 1, further comprising a plurality of software subroutines accessible by the CPU, where the plurality of software subroutines serve as an interface between application software executing on the CPU and the on-board video compression circuit.

15. In a personal computer (PC) motherboard, a method for performing video compression, the method comprising:
receiving a video signal through a video input interface of the PC motherboard; and
producing compressed video information by utilizing a video compression circuit on-board the PC motherboard to compress the received video signal.

16. The method claim 15, further comprising interfacing with a video card that is communicatively coupled to the PC motherboard through an expansion interface of the PC motherboard, where the video card is adapted to receive and compress a video signal.

17. The method of claim 16, further comprising:
managing the on-board video compression circuit; and
managing the video card.

18. The method of claim 16, further comprising coordinating simultaneous operation of the on-board video compression circuit and the video card.

19. The method of claim 15, further comprising communicating the compressed video information to a device external to the PC motherboard through a communication interface of the PC motherboard.

20. The method of claim 15, further comprising communicating the received video signal through a communication interface of the PC motherboard to a device external to the PC motherboard.

21. The method of claim 15, further comprising, while utilizing the video compression circuit on-board the PC motherboard to compress the received video signal, communicating the received video signal through a communication interface of the PC motherboard to a device external to the PC motherboard.

22. The method of claim 15, wherein receiving a video signal through a video input interface of the PC motherboard comprise receiving a video signal from video camera.

23. The method of claim 15, further comprising storing the compressed video information in a memory device external to the PC motherboard through a memory interface of the PC motherboard.

24. The method of claim 15, further comprising communicating video information to a video display system through a video output interface of the PC motherboard.

25. The method of claim 15, further comprising:
receiving an audio signal through an audio input interface of the PC motherboard; and
compressing the received audio signal to produce compressed audio information.

26. The method of claim 25, further comprising synchronizing the compressed video information and the compressed audio information.

27. The method of claim 15, further comprising storing compression control information stored in memory of the PC motherboard, where the compression control information controls a manner in which the on-board video compression circuit compresses the received video signal.

28. The method of claim 27, further comprising storing a plurality of software subroutines in memory of the PC motherboard, where the plurality of software subroutines serve as an interface between application software executing on a processor of the motherboard and the on-board video compression circuit.
